(19) United States
(12) Patent Application Publication
(10) Pub. No.: US 2007/0295585 A1
(43) Pub. Date: Dec. 27, 2007

(54) LIMIT SWITCH

(75) Inventor: Juergen Zimmermann, Bregenz (AT)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: ZIMM Maschinenelemente Gesellschaft m.b.H. & Co.

(21) Appl. No.: 11/766,953

(22) Filed: Jun. 22, 2007

(30) Foreign Application Priority Data
Jun. 22, 2006 (AT) A 1050/2006

(51) Int. Cl. H01H 21/28

(52) U.S. Cl. 200/47

(57) ABSTRACT

A limit switch comprises a switching part having an axially displaceable switching plunger for switching at least one switching contact, an actuating part by which the switching plunger is displaceable by a trigger part which runs against an actuating plunger of the actuating part transverse to the longitudinal axis of the switching plunger. The actuating part is mounted so as to be swivelable by a bearing part around a first swiveling axis and a second swiveling axis which extend parallel to one another and on both sides of the extended longitudinal axis of the switching plunger and are at a distance from the latter. The actuating part is swivelable from a basic position proceeding from the trigger part either in a first swiveling direction around the first swiveling axis or in an opposite, second swiveling direction around the second swiveling axis depending on the movement direction of the trigger part. The actuating plunger forms a first lever arm of the actuating part, and a control extension of the actuating part which forms a second lever arm of the actuating part has a control surface by which the switching plunger is axially displaceable when the actuating part swivels out of its basic position.

### CROSS-REFERENCE TO RELATED APPLICATION

This application claims priority of Austrian Application No. A 1050/2006, filed Jun. 22, 2006, the complete disclosure of which is hereby incorporated by reference.

### BACKGROUND OF THE INVENTION

a) Field of the Invention

The invention is directed to a limit switch with a switching part which has an axially displaceable switching plunger for switching at least one switching contact and with an actuating part by which the switching plunger is displaceable by a trigger part which runs against an actuating plunger of the actuating part transverse to the longitudinal axis of the switching plunger.

b) Description of the Related Art

Limit switches of the type mentioned above are used, for example, in screw jacks or spindle-type lifting gears which serve to position a load. The movement of the spindle-type lifting gear is stopped at designated end positions by means of the limit switches. For this purpose, a trigger part is arranged at that end of the spindle located across from the actuation end of the spindle. This trigger part is displaced together with the spindle in axial direction of the latter. The movement direction of the trigger part extends perpendicular to the longitudinal axis of an axially displaceable switching plunger of the limit switch by which at least one switching contact of the limit switch is switched. Since the switching plunger itself cannot be loaded by a force acting perpendicular to its longitudinal axis, the limit switch further has an actuating part with an actuating plunger at which a roller is rotatably mounted. The roller of the actuating plunger cooperates with an inclined surface of the trigger part by which the actuating plunger is displaced in axial direction and in so doing displaces the switching plunger of the limit switch.

Conventional limit switches of the type mentioned above have the drawback that the positioning of the trigger part relative to the limit switch may only have relatively close tolerances in order to achieve a reliable switching process. This is true particularly in limit switches with a plurality of switch contact points. In many limit switches a first switching point (the so-called snap contact) is reached after a predetermined displacement path of the switching plunger and a second switching point (the so-called forced opening) is reached after a further displacement path. The second switching point must be reliably reached when the trigger part makes contact. The switching plunger may only be displaced slightly beyond its second switching point in order not to damage the switching part.

### OBJECT AND SUMMARY OF THE INVENTION

It is the primary object of the invention to provide a limit switch of the type mentioned above in which the positioning of the limit switch relative to the trigger part can have a larger tolerance. According to the invention, this object is met by a limit switch comprising a switching part which has an axially displaceable switching plunger for switching at least one switching contact, an actuating part by which the switching plunger is displaceable by a trigger part which runs against an actuating plunger of the actuating part transverse to the longitudinal axis of the switching plunger, and a bearing part by which the actuating part is supported so as to be swivelable around a first swiveling axis and a second swiveling axis which extend parallel to one another and on both sides of the extended longitudinal axis of the switching plunger and are at a distance from the latter, wherein the actuating part is swivelable from a basic position proceeding from the trigger part either in a first swiveling direction around the first swiveling axis or in an opposite, second swiveling direction around the second swiveling axis depending on the movement direction of the trigger part, and the actuating plunger forms a first lever arm of the actuating part, and a control extension of the actuating part which forms a second lever arm of the actuating part has a control surface by means of which the switching plunger is axially displaceable when the actuating part swivels out of its basic position.

The construction according to the invention makes possible a larger switching reserve so that the tolerances for the mutual placement of the limit switch and of the trigger part can be larger.

Further, very low wear and, therefore, a long lifetime can be achieved in a limit switch according to the invention.

Inclined surfaces of the trigger part are not required in a limit switch constructed according to the invention.

In order not to cause a further displacement of the switching plunger when the actuating part is swiveled farther after reaching a swiveling angle of the actuating part at which the switching contact(s) are already switched by the switching part, the control surface advantageously has, for each swiveling direction, a portion with an arc-shaped contour whose circular center lies, respectively, on the swiveling axis of the actuating part around which the actuating part is swiveled for this swiveling direction. This swiveling axis is arranged on the opposite side of the extended longitudinal axis of the switching plunger with respect to the associated arc-shaped portion of the control surface.

Further advantages and details of the invention are described in the following with reference to the accompanying drawings in which additional objects of the invention are indicated.

### BRIEF DESCRIPTION OF THE DRAWINGS

In the drawings:

FIG. 1 shows an oblique view of a limit switch according to the invention;

FIG. 2 shows an exploded view of the limit switch (same viewing direction as FIG. 1);

FIG. 3 shows an exploded view from another viewing direction;

FIG. 4 shows a view of the actuating part;

FIG. 5 shows an oblique view of limit switches installed in a spindle-type lifting gear with a cutaway view of the guide pipe for the trigger part;

FIG. 6 shows an oblique view of a portion of the limit switch in the basic position of the actuating part;

FIG. 7 shows an oblique view, corresponding to FIG. 6, in a swiveling position of the actuating part;

FIG. 8 shows a side view of the limit switch mounted at a guide pipe guiding the trigger part;

FIG. 9 shows a section along line A-A of FIG. 8 (in the basic position of the actuating part); and

FIGS. 10 to 12 show different swiveling positions of the actuating part in a section corresponding to FIG. 9.

It should be noted that the figures have different scales.

### DESCRIPTION OF THE PREFERRED EMBODIMENT EXAMPLES

An embodiment example of a limit switch according to the invention is shown in the drawings. The limit switch has a switching part which is constructed in a conventional manner and need not be described in detail. Switching parts of this type are commercially available and are frequently used in limit switches, for example, in spindle-type lifting gears.

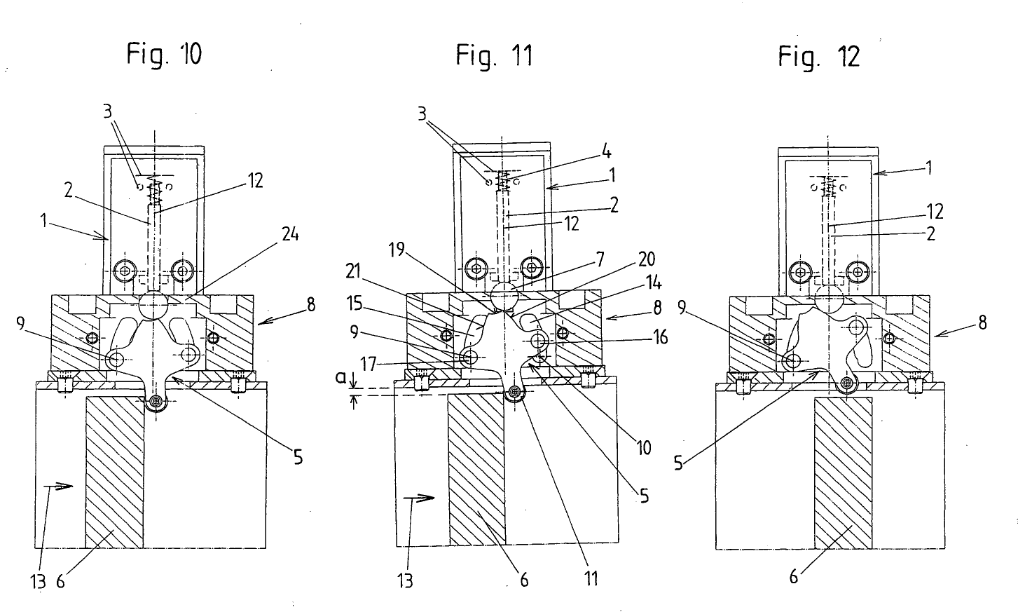

The switching part has an axially displaceable switching plunger 2. This switching plunger 2 serves to switch a switch contact 3 which is shown schematically in FIGS. 9 to 12. Two switching points are reached when the switching plunger 2 is displaced axially. When the first switching point is reached (see FIG. 10) when the switching plunger 2 is pressed in, the actuation of the switching contact 3 is carried out by a spring 4. This switching point is also commonly known as a “snap contact”. When the switching plunger 2 is pressed in farther than this, a second switching point is reached (see FIGS. 11 and 12). In this switching point, commonly referred to as “forced opening”, the switch contact 3 is actuated directly by the switching plunger 2. As was already mentioned, the parts arranged inside the switching part 3 are only shown schematically in FIGS. 9 to 12.

The limit switch further comprises an actuating part 5. This actuating part 5 serves to displace the switching plunger 2 axially with the intermediary of a transmission part 7 when the limit switch is actuated by a trigger part 6.

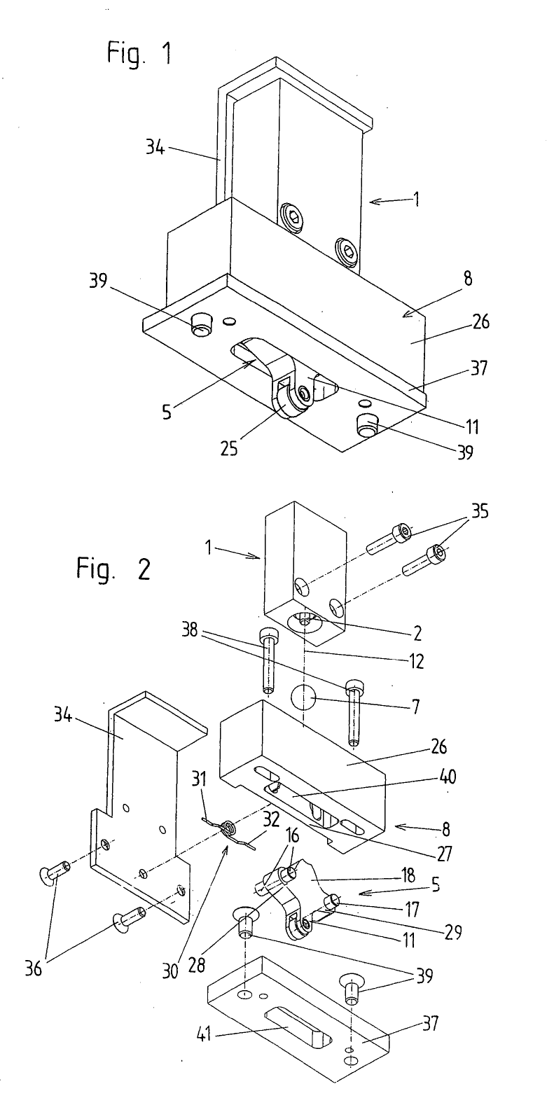

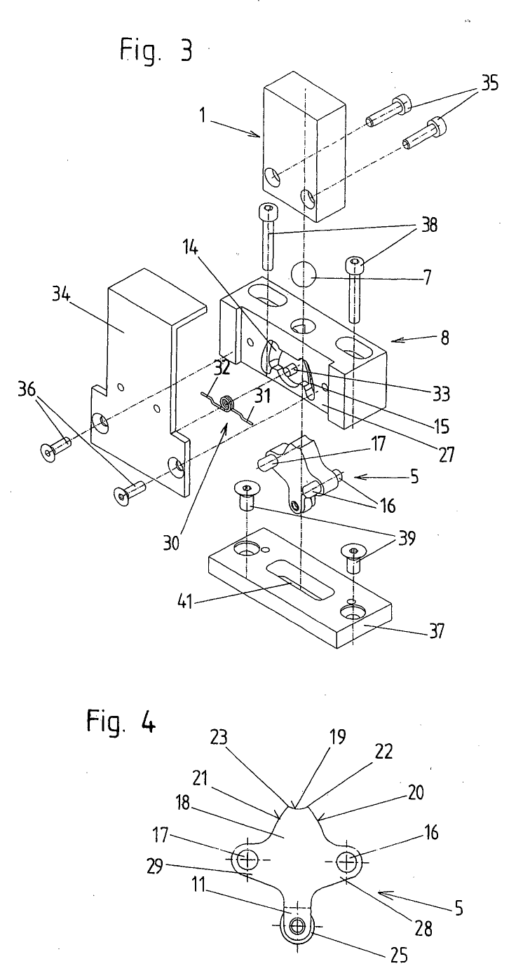

The actuating part 5 is supported in a bearing part 8 and is swivelable around swiveling axes 9, 10 proceeding from a basic position shown in FIGS. 1, 5, 6 and 9. It is swivelable around the first swiveling axis 9 in a first swiveling direction and around the second swiveling axis 10 in an opposite, second swiveling direction.

A portion of the actuating part 5 forms an actuating plunger 11 which serves to actuate the limit switch by means of the trigger part 6. The trigger part 6 moves transverse to, particularly at right angles to, the longitudinal axis 12 of the switching plunger 2 and moves toward the actuating plunger 11 in this movement direction 13 when the limit switch is actuated. Depending on which side of the trigger part 6 approaches the actuating plunger, the actuating part 5 swivels either around the first swiveling axis 9 or around the second swiveling axis 10.

The swiveling axes 9, 10 lie on both sides of the extended longitudinal axis 12 of the switching plunger 2 and are at a distance from the latter, preferably equidistant therefrom. The swiveling axes 9, 10 are advantageously oriented at right angles to the longitudinal axis 12 of the switching plunger 2.

An imaginary straight connecting line between the first and second swiveling axes 9, 10 extends at right angles to the longitudinal axis 12 of the switching plunger 2.

The movement direction 13 of the trigger part 6 is advantageously oriented at right angles to the swiveling axes 9, 10.

First and second guide plates are provided for supporting the actuating part 5 so as to be swivelable around the first swiveling axis 9 and the second swiveling axis 10. In the present embodiment example, the bearing part 8 has first and second guide plates 14, 15 in which first and second pins 16, 17 of the actuating part 5 are guided. The guide plates 14, 15 are arc-shaped, the circular center of the first guide plate 14 lies on the first swiveling axis 9 and the circular center of the second guide plate 15 lies on the second swiveling axis 10.

In the basic position of the actuating part 5 in which it is not swiveled, the second pin 17 is located at the first swiveling axis 9, i.e., the longitudinal axis of the second pin 17 coincides with the first swiveling axis 9, and the first pin 16 is located at the second swiveling axis 10, i.e., the longitudinal axis of the first pin 16 coincides with the second swiveling axis 10. When the actuating part 5 is swiveled in the first swiveling direction around the first swiveling axis 9 proceeding from this basic position, the second pin 17 remains at the first swiveling axis 9 and the second pin 16 moves along the first guide plate 14. When the actuating part 5 is swiveled in the opposite swiveling direction around the second swiveling axis 10, the first pin 16 remains at the second swiveling axis 10 and the second pin 17 moves along the second guide plate 15.

During the swiveling of the actuating part 5 around the first swiveling axis 9, the actuating plunger 11 forms a first lever arm and a control extension 18 forms a second lever arm which is swiveled around the first swiveling axis 9. In a corresponding manner, when swiveling around the second swiveling axis 10, the actuating plunger 11 forms a first lever arm which is swiveled around this swiveling axis 10 and the control extension 18 forms a second lever arm which is swiveled around the second swiveling axis 10.

The control extension 18 has a control surface which cooperates with the transmission part 7. This control surface comprises a central portion with a depression 19 which is contacted by the transmission part 7 in the basic position of the actuating part 5 in which it is not swiveled. The extended longitudinal axis 12 of the switching plunger 2 extends through the deepest point of the depression 19 in the basic position of the actuating part 5.

The depression is bounded on both sides by cams 22, 23. Adjoining these cams 22, 23, respectively, is a convex portion 20, 21 in which the control surface is formed in an arc-shaped manner viewing the actuating part 5 in direction of the swiveling axes 9, 10. The first portion 20 cooperates with the transmission part 7 when the actuating part 5 swivels to a sufficient extent around its first swiveling axis 9 and the second portion 21 cooperates with the transmission part 7 when the actuating part 5 swivels to a sufficient extent around its second swiveling axis 10. The circular center of the arc-shaped contour of the first portion 20 is located on the first swiveling axis 9 which, in the basic position of the actuating part 5, is arranged on the side of the extended longitudinal axis 12 of the switching plunger 2 located across from the first portion 20. The circular center of the arc-shaped contour of the second portion 21 is located on the second swiveling axis 10 which, in the basic position of the actuating part 5, is arranged on the side of the extended longitudinal axis 12 of the switching plunger 2 located across from the second portion 21. In other words, the portions 20, 21 are formed in each instance by a generatrix which is moved in an arc-shape around the longitudinal axis of the respective oppositely located pin 16, 17. This generatrix is preferably a straight line extending parallel to the longitudinal axes of the pins 16, 17.

The transmission part 7 is guided by the bearing part 8 so as to be displaceable in direction of the longitudinal axis 12 of the switching plunger 2, namely, by the edge of a recess in a cover wall 24 of the bearing part 8. The bearing part 8 is preferably formed as a rolling body, for example, in the shape of a ball or roller.

A roller 25 cooperating with the trigger part 6 can be rotatably supported at the actuating plunger 11 as is shown.

In the present embodiment example, the first guide plate 14 and the second guide plate 15 are formed by two arc-shaped recesses in a front wall 26 and a rear wall 27 of the bearing part 8. Portions of the first pin 16 and of the second pin 17 which project from both sides of the actuating part 5 project into these recesses. For example, the recess in the rear wall 27 can be formed as an arc-shaped elongated hole, as is shown, and the respective recess in the front wall 26 can be formed by an arc-shaped depression (not shown in the drawings).

In the present embodiment example, the actuating part 5 has four extensions. A first extension 28 and a second extension 29 at which the first pin 16 and second pin 17 are arranged (see FIG. 4) are provided on opposite sides. An extension forming the actuating plunger 11 and the control extension 18 extend in directions at right angles to the directions in which the first extension 28 and second extension 29 extend.

Further, a spring 30 is provided which acts upon the actuating part 5 in its basic position in which it is not swiveled. This spring 30 is formed as a helical spring with spring arms 31, 32 projecting on opposite sides. The central portion of the spring 30 is arranged on a pin 33 of the bearing part 8, and the two spring arms 31, 32 contact the first pin 16 and second pin 17 of the actuating part 5.

In the present embodiment example, the switching part 1 and the bearing part 8 are connected to one another by a connection plate 34 to which they are screwed by screws 35, 36. Further, a fastening plate 37 is provided which serves to fasten the limit switch to a desired part. In the present embodiment example, the bearing part 8 is screwed to the fastening plate 37 by screws 38. Screws 39 penetrating holes in the fastening plate 37 serve to fasten the limit switch to a desired part.

The actuating plunger 11 projects beyond the rest of the parts of the limit switch. In the present embodiment example, recesses 40, 41 for the passage of the actuating plunger 11 are provided in the bearing part 8 and in the fastening plate 37.

The fastening plate 37 could also be formed integral with the bearing part 8 for example.

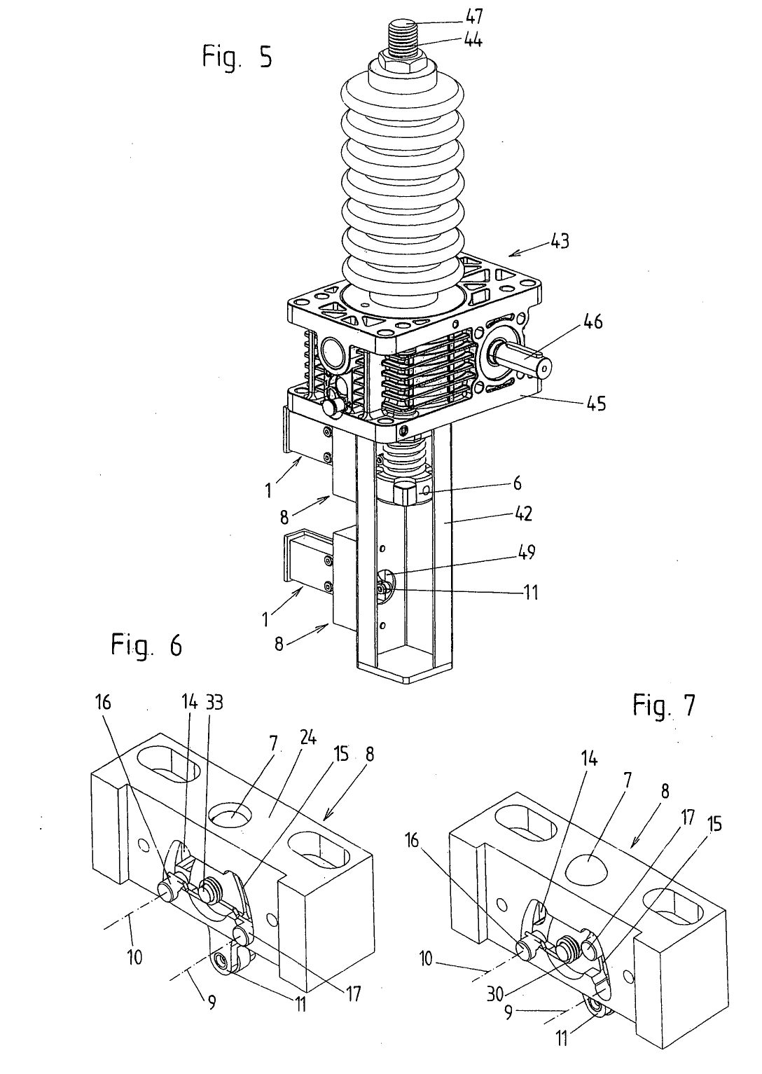

FIG. 5 shows by way of example a possible application for a limit switch according to the invention. In this application example, two limit switches according to the invention are mounted at a guide pipe 42 of a spindle-type lifting gear 43. Spindle-type lifting gears of this type are used for positioning loads. In the form shown in FIG. 5, the spindle-type lifting gear has a spindle 44 which is adjustable in axial direction. For this purpose in a conventional manner, the spindle-type lifting gear has a spindle nut inside the gear housing 45, which spindle nut is supported so as to be rotatable but fixed with respect to displacement and is arranged on the external thread of the spindle 44 and is rotatably displaceable by the rotation of a driveshaft 46. For example, a worm is arranged on the driveshaft 46 inside the gear housing 45 for this purpose and cooperates with a worm toothing of the spindle nut. Spindle-type lifting gears of this type are known.

One end 47 of the spindle 44 serves to connect to the load to be positioned. Arranged at the other end is a trigger part 6 by which the limit switch can be actuated. In this embodiment, this trigger part 6 serves at the same time as means for preventing rotation of the spindle 44 in that it is guided in the guide pipe 42 so as to be displaceable but fixed with respect to rotation.

The limit switches are screwed by their fastening plates 37 to the guide pipe 42. Openings 49 for the passage of the actuating plunger 11 are formed in the guide pipe 42.

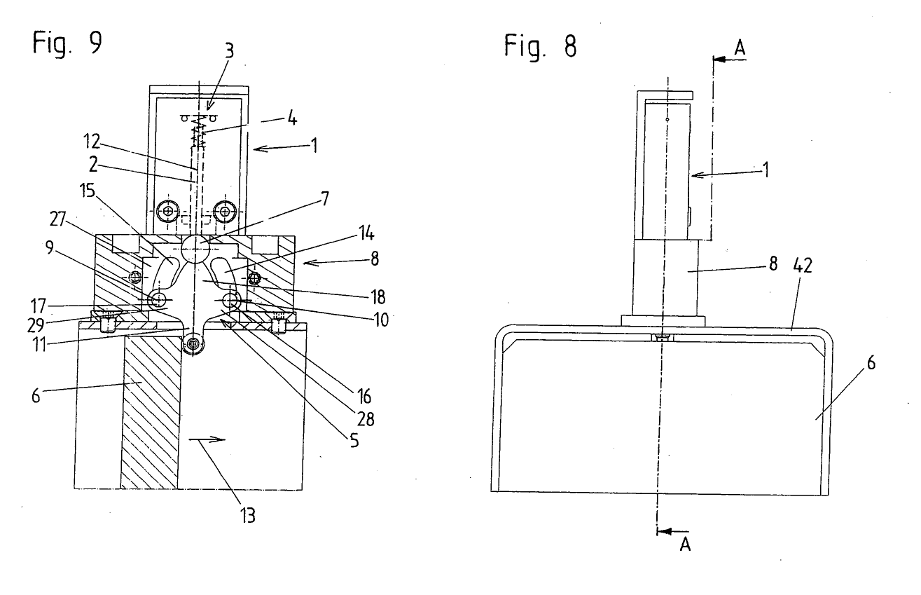

The switching process of a limit switch will be described in the following with reference to FIGS. 9 to 12. FIGS. 8 to 12 again show a limit switch mounted at a guide pipe 42. The trigger part 6 has a somewhat simpler construction compared to FIG. 5.

In the switching position shown in FIG. 9, the actuating part 5 is in its basic position in which the longitudinal axes of the pins 16, 17 coincide with the swiveling axes 9, 10. The switching plunger 2 is in its maximum pushed-out position. The transmission part 7 preferably contacts the end of the switching plunger 2. In FIG. 9, the trigger part 6 runs in a straight line against the actuating plunger 11.

In the position shown in FIG. 10, the trigger part 6 has moved farther in its movement direction 13 so that it has swiveled the actuating part 5 around its first swiveling axis 9 relative to the basic position. The transmission part 7 has accordingly been pushed out of its deepest position in the depression 19 and has moved against the switching plunger 2 in direction of the longitudinal axis 12 of the switching plunger 2 and in so doing has displaced the latter against the force of the spring 4. In the position shown in FIG. 10, the first switching point of the switching part 1 in which the switching contact 3 is opened has just been reached.

When the trigger part 6 is displaced farther in its movement direction 13, the actuating part 5 swivels farther around the first swiveling axis 9. FIG. 11 shows a position in which the cam 22 is in proximity to the extended longitudinal axis 12 of the switching plunger 2. When the actuating part 5 is swiveled farther from its swiveling position shown in FIG. 10 into its swiveling position shown in FIG. 11, the transmission part 7 is displaced farther toward the switching plunger 2 accompanied by displacement thereof. In the position according to FIG. 11, the second switching point of the switching part 1 is reached.

When the cam 22 is located precisely on the imaginary straight connection line between the first swiveling axis 9 and the center of the transmission part 7, the position in which the switching plunger 2 is pressed in to the maximum extent has been reached.

When the trigger part 6 is displaced farther in its movement direction 13, the actuating part 5 swivels farther around its first swiveling axis 9. The point of contact of the transmission part 7 at the actuating part 5 accordingly moves along the portion 20 of the control surface of the actuating part 5 and the switching plunger 2 is not pressed in farther. FIG. 12 shows the farthest possible swiveling of the actuating part 5 around the first swiveling axis 9 (this swiveling is greater than the maximum swiveling achieved by the trigger part 6 as can be seen from the distance between the actuating plunger 11 and the trigger part 6). Accordingly, the swiveling angle between the switching position shown in FIG. 11 and the switching position shown in FIG. 12 forms a switching reserve for reaching the second switching point of the switching part 1. The distance a between the trigger part 6 and the guide pipe 42 can accordingly also be appreciably greater than that shown in the drawing. However, the second switching point is reached, although the maximum swiveling of the actuating part 5 by means of the trigger part 6 is smaller. Also, the distance a can be smaller than that shown without resulting in damage to the limit switch as can be seen from FIG. 12. The distance a can vary within a relatively large range in which the second switching point is reached and without leading to damage to the limit switch. This is made possible by the large switching reserve of the limit switch according to the invention. This substantially facilitates mounting of such limit switches because the distances a can vary as a result of manufacturing tolerances.

The limit switch according to the invention can advantageously be used for trigger parts 6 that can run against the actuating plunger 11 from both sides, these trigger parts 6 moving transverse to the longitudinal axis 12 of the switching plunger 2. When the trigger part 6 runs against the actuating plunger 11 from the side opposite that shown in FIGS. 9 to 12 in a movement direction opposite to movement direction 13, the actuating part 5 is swiveled around the swiveling axis 10 in an analogous manner.

Various modifications of the embodiment form shown in the drawings are conceivable and possible without departing from the scope of the invention. For example, the guide plates 14, 15 could be arranged at the actuating part and the pins 16, 17 engaging in the guide plates 14, 15 could be arranged at the bearing part 8. In the basic position of the actuating part 5 in which it is not swiveled, the pins 16, 17 would be located at the ends of the guide plates remote of the actuating plunger 11.

In the present embodiment example, the switching part 1 has a switching contact with two switching points. The switching part 1 can also have only one individual switching point. Also, in this case, a larger switching reserve can be achieved by means of the invention. The switching part 1 can also have more than one switching contact which can be actuated at one switching point or at different switching points.

Also, an increased switching reserve compared to conventional limit switches can be achieved when the convex portions 20, 21 of the control surface of the control extension 18 do not have an exactly arc-shaped construction. However, the arc-shaped construction of the portions 20, 21 described in the embodiment example is preferred.

As follows from the preceding description, the scope of the invention is not limited to the embodiment examples shown herein, but rather should be defined with reference to the appended claims together with their fill range of possible equivalents.

While the preceding description and drawings show the invention, it will be obvious to a person skilled in the art that various modifications can be made without departing from the spirit and scope of the invention.

### REFERENCE NUMBERS

1 switching part
2 switching plunger
3 switching contact
4 spring
5 actuating part
6 trigger part
7 transmission part
8 bearing part
9 first swiveling axis
10 second swiveling axis
11 actuating plunger
12 longitudinal axis
13 movement direction
14 first guide plate
15 second guide plate
16 first pin
17 second pin
18 control extension
19 depression
20 portion
21 portion
22 cam
23 cam
24 cover wall
25 roller
26 front wall
27 rear wall
28 first extension
29 second extension
30 spring
31 spring arm
32 spring arm
33 pin
34 connection plate
35 screw
36 screw
37 fastening plate
38 screw
39 screw
40 recess
41 recess
42 guide pipe
43 spindle-type lifting gear
44 spindle
45 gear housing
46 driveshaft
47 end
49 opening

What is claimed is:

1. A limit switch comprising:
a switching part having an axially displaceable switching plunger for switching at least one switching contact;
an actuating part by which the switching plunger is displaceable by a trigger part which runs against an actuating plunger of the actuating part transverse to the longitudinal axis of the switching plunger;
a bearing part by which the actuating part is supported so as to be swivelable around a first swiveling axis and a second swiveling axis which extend parallel to one another and on both sides of the extended longitudinal axis of the switching plunger and are at a distance from the latter;
said actuating part being swivelable from a basic position proceeding from the trigger part either in a first swiveling direction around the first swiveling axis or in an opposite, second swiveling direction around the second swiveling axis depending on the movement direction of the trigger part;
said actuating plunger forming a first lever arm of the actuating part; and
a control extension of the actuating part which forms a second lever arm of the actuating part having a control surface by which the switching plunger is axially displaceable when the actuating part swivels out of the basic position of the actuating part.

2. The limit switch according to claim 1, wherein the actuating part is supported by means of first and second slotted guides so as to be swivelable around the first swiveling axis and the second swiveling axis, and the slotted guides have first and second guide plates in which first and second pins are guided so as to be displaceable and which have arc-shaped paths whose circle centers lie on the first swiveling axis and second swiveling axis.

3. The limit switch according to claim 2, wherein the guide plates are arranged in the bearing part and the pins are arranged at the actuating part.

4. The limit switch according to claim 1, wherein the straight connection line which connects the first swiveling axis and second swiveling axis and which extends at right angles to the first swiveling axis and second swiveling axis is oriented at right angles to the longitudinal axis of the switching plunger.

5. The limit switch according to claim 1, wherein the first swiveling axis and the second swiveling axis are at the same distance from the extended longitudinal axis of the switching plunger.

6. The limit switch according to claim 1, wherein a transmission part is arranged between the control surface of the second lever arm of the actuating part and the switching plunger, which transmission part contacts the control surface on one side and contacts the switching plunger on the other side and is guided so as to be displaceable in direction of the longitudinal axis of the switching plunger.

7. The limit switch according to claim 6, wherein the transmission part is guided by a recess of the bearing part so as to be displaceable in axial direction of the switching plunger.

8. The limit switch according to claim 6, wherein the transmission part is a rolling body, preferably a ball or a roller.

9. The limit switch according to claim 1, wherein the control surface of the actuating part has a central depression.

10. The limit switch according to claim 9, wherein the transmission part engages in the depression in the basic position of the actuating part in which the actuating part is not swiveled.

11. The limit switch according to claim 9, wherein the control surface has convex portions on both sides of the depression adjoining cams which delimit the depression.

12. The limit switch according to claim 11, wherein the portions have arc-shaped contours when the actuating part is viewed in direction of the swiveling axes, the circular centers of these arc-shaped contours lying on the swiveling axis, respectively, around which the actuating part is swiveled when the respective portion cooperates with the transmission part.

13. The limit switch according to claim 1, wherein the actuating part is acted upon by a spring in the basic position of the actuating part in which it is not swiveled.

14. The limit switch according to claim 13, wherein the spring has a central portion that is held at the bearing part and has spring arms which project from both sides of this portion and which engage, respectively, at the actuating part.

15. The limit switch according to claim 1, wherein a roller for cooperating with the trigger part is rotatably supported at the actuating plunger.
